(19) United States
(12) Patent Application Publication
(10) Pub. No.: US 2010/0133809 A1
(43) Pub. Date: Jun. 3, 2010

(54) Adapter bit for a device for connecting pipe conduits

(76) Inventors: Philipp Pustelnik, Wien (AT); Thomas Euller-Rolle, Wien (AT)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/921,133

(22) PCT Filed: Mar. 16, 2006
(86) PCT No.: PCT/AT2006/000112

§ 371 Date: Mar. 12, 2009

(30) Foreign Application Priority Data
May 24, 2005 (AT) A 882/2005

(51) Int. Cl. F16L 5/00

(52) U.S. Cl. 285/142.1

(57) ABSTRACT

The invention relates to an adapter bit (6) for the parallelepiped liquid distributing section (2) of a liquid treatment device (1) which is provided in a corner area with a flattened section (3) on which the adapter bit (6) can be placed. The adapter bit (6) has a base (6′) with a liquid passage (7) corresponding to the liquid passage (4) of the flattened section (3), and a pipe conduit connection (10) which is configured as a universal connector. A base section (6′) of the adapter bit comprises a seat (11) for a temperature sensor (12) which sensor is embedded into the seat by means of a casting compound (13). A connecting cable (14) leading away from the base section (6′) comprises an electrical connector (15) via which the temperature sensor (12) is connected to a temperature control device.

The invention relates to an adapter cap for a device for connecting pipe lines to the distributor section of a liquid treatment arrangement, in particular an hydraulic fluid air cooling apparatus, which is customarily installed in the return portion of a hydraulic fluid operating circuit of mobile or stationary installations. As a rule, the cooling elements of the cooling apparatus through which the hydraulic fluid flows and which are combined into a package consist of aluminum plates and rods, which are surrounded by air fins and are connected with a box-shaped distributor section extending over the top of the package. An installed fan furthermore acts on the cooling elements.

To avoid the necessity of having to stock connectors of different dimensions for different models of cooling apparatus, and to make the installation of the cooling apparatus easier, the parallelepiped distributor section of the liquid treatment arrangement in accordance with EP 0 983 475 B1 is provided in a corner area with a flattened section, in which a passage for a liquid is provided. Furthermore, a hollow adapter cap is provided, which can be placed on this flattened section and is substantially pyramid-shaped and has a base with a passage for a liquid, which corresponds to the passage for the liquid in the flattened section, and a pipe line connection. This allows the installation of the adapter cap on the flattened corner section at different orientations in such a way that, depending on the requirements, the pipe line connector is pointed to the rear, upward or to the side. At the same time it is possible to stock different adapter caps, which are matched in respect to diameter and screw thread to the connecting opening of the pipe lines to be connected, so that in an economically advantageous manner it is necessary to produce and keep in stock only a single model of the liquid treatment arrangement.

However, a problem in regard to this connecting device and its adapter cap resides in that it is necessary to install and connect the temperature sensor required for regulating the cooling apparatus separately at some location of the hydraulic fluid line, or in the cooling apparatus itself, which is relatively expensive constructively and in view of installation technology, and requires a refinishing of the screw threads following the heat treatment, because of which the cooling apparatus can become contaminated by dirt.

Therefore the object of the present invention lies in creating an improved connecting device, which requires less outlay for temperature detection and control than previously.

The subject of the invention is an adapter cap for the parallelepiped distributor section of a liquid treatment arrangement, which is provided with a flattened section in a corner area, on which the adapter cap can be placed, wherein the adapter cap has a base with a passage for a liquid which corresponds to the passage for the liquid in the flattened section, and a pipe line connection. In accordance with the invention, this adapter cap is distinguished in that the pipe line connection is embodied as a universal connector, and that a receptacle for a temperature sensor, which has been embedded into the receptacle by means of a casting compound, is provided in a base section of the adapter cap, wherein a connecting cable with an electrical plug connector leading away from the base section is provided, by means of which the temperature sensor can be connected with a temperature regulating arrangement.

In what follows, the invention will be explained in greater detail by means of an exemplary embodiment of an hydraulic fluid air cooling apparatus, making reference to the drawings, in which are shown in:

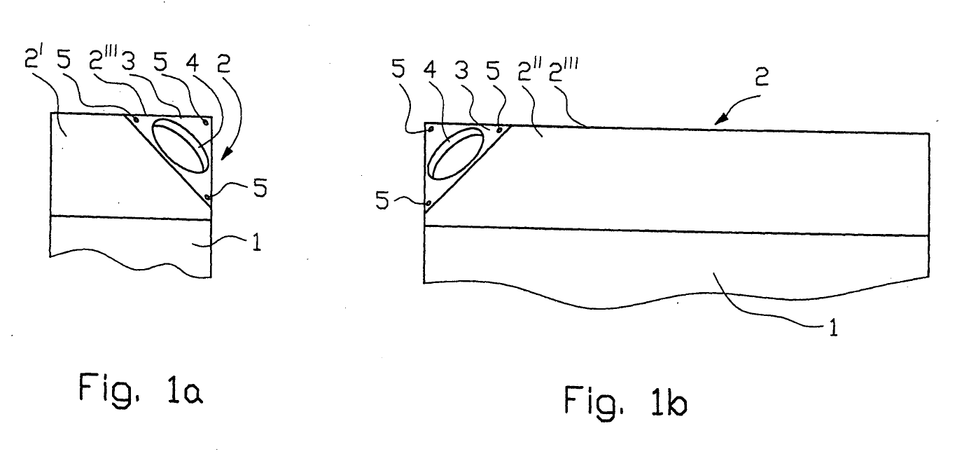

FIG. 1a the distributor, or head, section of an hydraulic fluid air cooling apparatus in accordance with the invention in a front view,

FIG. 1b a lateral view of FIG. 1a,

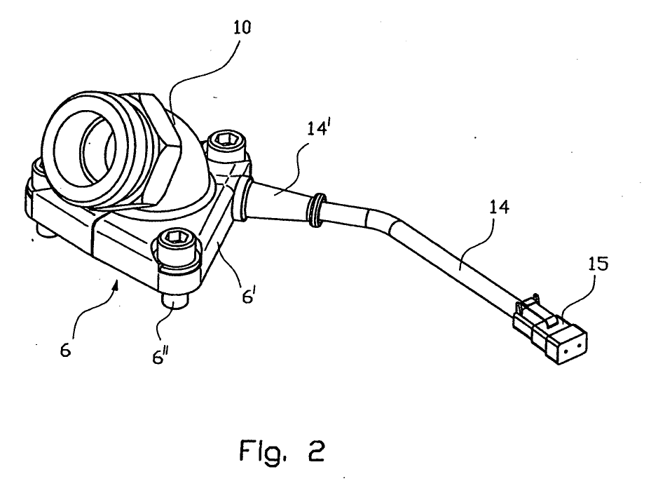

FIG. 2 an adapter cap for the head section in a lateral view,

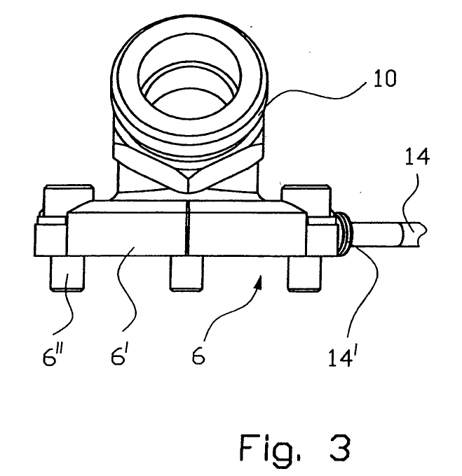

FIG. 3 the adapter cap in FIG. 2 seen from the direction of the other side,

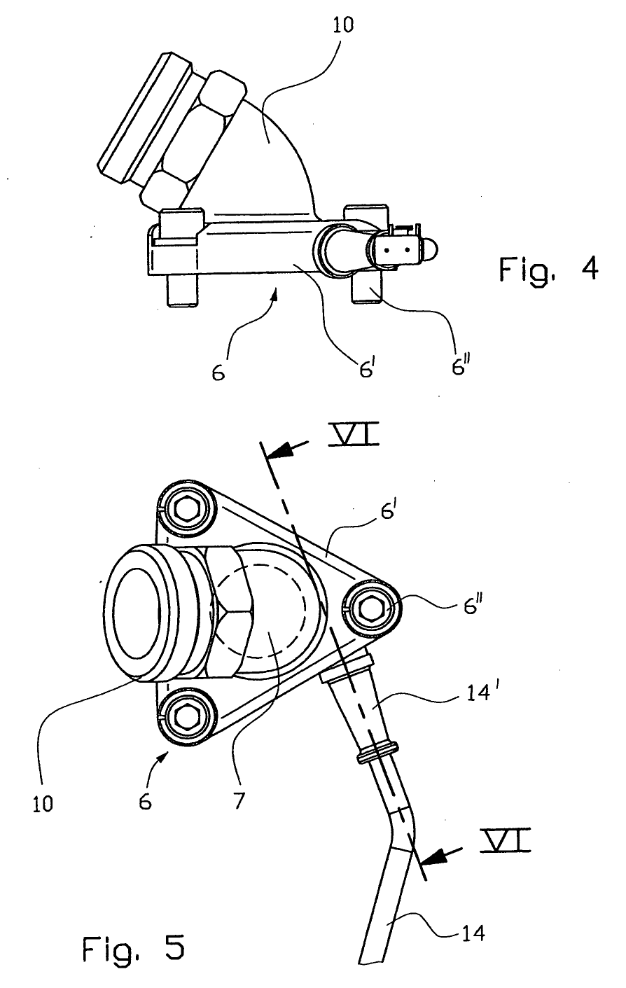

FIG. 4 a plan view in the direction of the arrow IV′ in FIG. 2,

FIG. 5 a plan view in the direction of the arrow V in FIG. 2, and

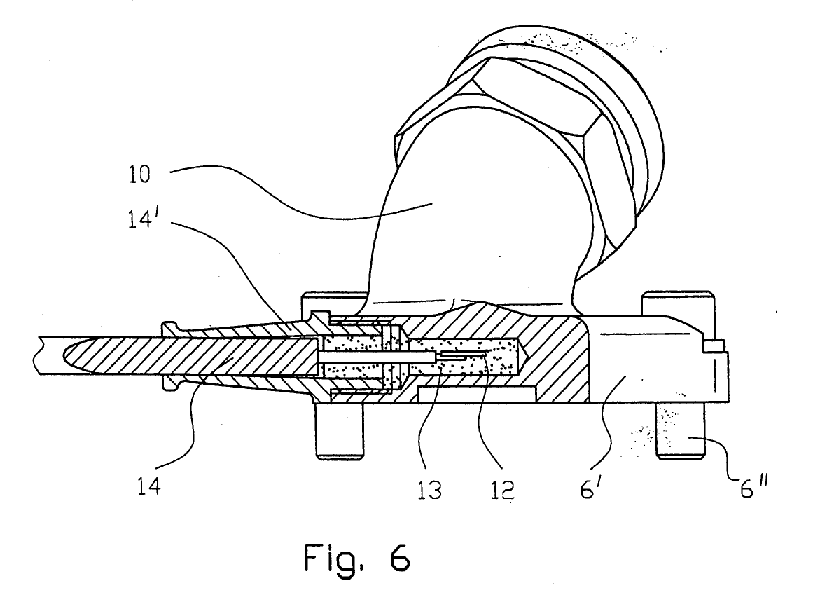

FIG. 6 a section through the adapter cap along the line VI-VI in FIG. 5.

In accordance with FIG. 1, an hydraulic fluid air cooling apparatus, which is actually formed by a parallelepiped package 1 of spaced-apart aluminum plates, which are provided with air fins, wherein a fan, not represented, is assigned to the package, is provided with a distributor, or head section 2, which is used as a connection with feed and return lines, not represented, on the cooling apparatus and functions as an hydraulic fluid distributor.

In a corner area, the hydraulic fluid distributor section 2, which also has the shape of a parallelepiped or box, is provided with a flattened section 3, which cuts off the corner and makes a transition into the front face 2′, the longitudinal side 2″ and the top 2″′ of the distributor 2.

The flattened section 3 is provided with an oil passage opening 4 of a comparatively large diameter, and with three screw holes 5.

A hollow adapter cap 6, represented in a perspective view in FIG. 2, and which is substantially triangular in a view from above, is mounted on the flattened section 3. The adapter cap 6 has a substantially triangular base section 6′, which is placed on the flattened section 3. The base section 6′ is provided with threaded bolts 6″, which fit into screw holes 5. In accordance with FIG. 5, the base section 6′ has a central connecting opening 7, which corresponds to the oil passage opening 4 of the flattened section 3.

It ensues from FIG. 5 that a universal connection piece 10 extends away in a curved manner from the connecting opening 7. The adapter cap 6 is mounted on the distributor 2 in the desired orientation of this connecting piece 10. A receptacle 11 for a temperature sensor 12 is provided in the base section 6′ of the adapter cap 6 and has been embedded into the receptacle 11 by means of a casting compound 13, wherein a connecting cable 14 leading out of a cable socket 14′ away from the base section 6′ is provided with an electrical plug connector 15, by means of which the temperature sensor can be connected with a temperature regulating arrangement, not represented.

Within the scope of the invention, numerous adapter caps 6 with connecting openings of different sizes and universal connecting pieces 10 of various types of threads can be stocked, which can be installed in a simple manner on the same type of hydraulic fluid air cooling apparatus, or other liquid treatment arrangements.

We claim

1. An adapter cap (6) for a parallelepiped distributor section of a liquid treatment arrangement, which is provided with a flattened section in a corner area, on which the adapter cap can be placed, wherein the adapter cap comprises:
a base with a passage for a liquid, which corresponds to a passage for the liquid in the flattened section, and
a pipe line connection, wherein the pipe line connection comprises a universal connector (10),
a receptacle (11) for a temperature sensor (12), which has been embedded into the receptacle (11) by a casting compound (13), is provided in said base of the adapter cap (6),
a connecting cable (14) with an electrical plug connector (15) leading away from said base, with which the temperature sensor (12) can be connected with a temperature regulating arrangement.
